(19) United States
(12) Patent Application Publication
(10) Pub. No.: US 2026/0183987 A1
(43) Pub. Date: Jul. 2, 2026

(54) Work table for a sawing machine

(71) Applicant: Hilti Aktiengesellschaft, Schaan (LI)

(72) Inventor: Benno LAIPPLE, Kaltental (DE)

(21) Appl. No.: 19/355,203

(22) Filed: Oct. 10, 2025

(30) Foreign Application Priority Data
Oct. 30, 2024 (EP) 24209798.8

(51) Int. Cl. B28D 7/02; B28D 1/04; B28D 7/04

(52) U.S. Cl. CPC B28D 7/02; B28D 1/04; B28D 7/04

(57) ABSTRACT

A work table for a sawing machine, wherein the work table (300) includes the following: a platform having a first longitudinal guide (302) and a second longitudinal guide (304) arranged parallel to the first longitudinal guide (302); a first table plate (310) which is movable longitudinally along the first longitudinal guide (302); a second table plate (312) which is movable longitudinally along the second longitudinal guide (304), wherein the first and second longitudinal guide (302, 304) are arranged between the first and second table plates (310, 312), and wherein the first longitudinal guide (302) is spaced apart from the second longitudinal guide (304) perpendicularly to the longitudinal direction such that there is a gap region between the first and second longitudinal guide (304).

### This claims priority to European Patent Application EP 24209798.8 filed on Oct. 30, 2024 and hereby incorporated by reference herein.

The present invention relates to a work table for a sawing machine, in particular for a stone sawing machine. The present invention also relates to a sawing machine for stone materials, having the work table according to the invention.

### BACKGROUND OF THE INVENTION

Stone saws are special machines which are used for sawing hard materials such as brick, concrete or natural stone. They are essential in the building industry and in renovation work, since they allow precise and efficient cuts to be made in materials which cannot be processed using conventional saws.

### SUMMARY OF THE INVENTION

A main concern with the use of stone saws is dust formation, since the corresponding fine particles put the health of workers at risk and can pollute the working environment. For this reason, two main methods for dust avoidance are used: water sprinkling and air extraction.

In stone saws with water sprinkling, water is conducted to the interface in order to bind dust particles as soon as they arise. The water reduces the dust effectively and prevents it from passing into the workers' breathing air. At the same time the applied water cools the saw blade, increasing the lifetime thereof and preventing overheating. A drawback of water sprinkling is that it requires a water connection, which is not present at some construction sites or is only poorly accessible. Water sprinkling also results in dirty water, which collects on the work table of the saw and has to be discharged.

In the case of air extraction, the dust that arises is extracted directly by a suction-extraction device on the saw or close to the interface and is conducted into a filter bag or tank. Suction extraction keeps the work environment dry and cleaner, this being suitable particularly for working in internal spaces. No dirty water arises, and the method can be employed more flexibly. However, air extraction operations are often less effective for dust removal than water.

In order to improve the effectiveness of air extraction, it is known practice to provide a longitudinal slot in the work table, with at least a lower end region of the saw blade extending into said slot. Suction extraction can take place directly via the longitudinal slot in the work table, and so the suction extraction takes place very close to the contact between the saw blade and the workpiece. In this way, the suction-extraction effect can be improved. However, it has been found that such a longitudinal slot in the work table reduces the stability of the work table. As a result, tensions can arise in particular in the case of heavy workpieces. The tensions may have the result that the work table can no longer be moved smoothly. Moreover, the orientation of the work table with respect to the workpiece may be impaired, and this may result, under certain circumstances, in cuts that are not straight.

It is an object of the present invention to provide a work table for sawing machines, which exhibits sufficient stability and at the same time allows direct suction extraction in the area of contact between the saw blade and the workpiece.

Accordingly, the present invention relates to a work table for a sawing machine, wherein the work table is designed to carry a workpiece, and wherein the work table comprises the following:
a platform having a first longitudinal guide and a second longitudinal guide arranged parallel to the first longitudinal guide;
a first table plate which is movable longitudinally along the first longitudinal guide;
a second table plate which is movable longitudinally along the second longitudinal guide,
   wherein the first and second longitudinal guide are arranged between the first and second table plates, and wherein the first longitudinal guide is spaced apart from the second longitudinal guide perpendicularly to the longitudinal direction such that there is a gap region between the first and second longitudinal guide.

In other words, a basis of the present invention is that the work table is split in two. In this case, the work table is subdivided into two table plates that are guided independently of one another. The two table plates are anchored stably in their respective longitudinal guides. Accordingly, it is not necessary to connect the two table plates together, at least for the stability of the work table. Rather, the two table plates can be connected on account of desired synchronization. For that purpose, however, a small/lightweight connecting element is sufficient, since this does not have to support the weight of the table plates or of the workpiece. Furthermore, as a result of the work table being divided into two table plates, a gap region can be provided between the two longitudinal guides, i.e. between the two table plates. The gap region can extend along the entire longitudinal direction of the work table, and so a suction-extraction device can be introduced very easily into the gap region. Accordingly, the suction-extraction device does not have to be an integral part of the work table, but rather can be designed to be both exchangeable and retrofittable.

According to a further embodiment, the first table plate comprises first guide means, in particular guide rollers, which are received in the first longitudinal guide so as to be movable along the longitudinal direction, and/or wherein the second table plate comprises first guide means, in particular guide rollers, which are received in the first longitudinal guide so as to be movable along the longitudinal direction. According to this embodiment, the first and second table plates are movable particularly easily and are guided reliably along the longitudinal direction.

According to a further embodiment, the work table comprises a third longitudinal guide which is arranged parallel to the first longitudinal guide and on an opposite side of the first longitudinal guide from the second longitudinal guide.

According to a further embodiment, the first table plate is arranged movably between the first and the third longitudinal guide, wherein the first table plate preferably comprises second guide means, in particular guide rollers, which are received in the third longitudinal guide so as to be movable along the longitudinal direction. In other words, the table plate is clamped in place between two longitudinal guides, with the result that the stability is improved even further. Alternatively, however, it is also conceivable for only one side of the first table plate to be received in a longitudinal guide, while the other side slides, for example, over a longitudinal strut of the platform. According to this exemplary embodiment, the dead weight of the first table plate and optionally of the workpiece can be distributed to two sides of the table plate.

According to a further embodiment, the work table comprises a fourth longitudinal guide which is arranged parallel to the second longitudinal guide and on an opposite side of the second longitudinal guide from the first longitudinal guide.

According to a further embodiment, the second table plate is arranged movably between the second and the fourth longitudinal guide, wherein the second table plate preferably comprises second guide means, in particular guide rollers, which are received in the fourth longitudinal guide so as to be movable along the longitudinal direction.

According to a further embodiment, the first and/or the second longitudinal guide have a substantially C-shaped cross section. As will be explained in more detail below, the C-shaped cross section of the longitudinal guides allows the guide means of the table plates to be guided reliably. Moreover, the guide means of the table plates can be protected against dust infiltration by the C profile. In other words, the dust that arises during sawing does not impair the guidance behaviour of the table plates. Rather, the dust thus produced is extracted in the gap region between the C-shaped longitudinal guides. In this case, it is particularly advantageous when the C profiles of the longitudinal guides are open away from the gap region, such that dust which is drawn in via the gap region cannot penetrate into the C profile.

According to a further embodiment, the first table plate is connected, preferably releasably, to the second table plate such that the first table plate is movable synchronously with the second table plate. As a result of the synchronization of the movement of the two table plates, the workpiece can be moved in a straight line towards the saw blade. The synchronization can be achieved via a connecting element between the two table plates. For example, the connecting element can be arranged at an end of the table plates that is remote from the saw blade. The connecting element, or synchronizing element, may be connected in particular releasably to the two table plates. Thus, the user can selectively move the table plates synchronously or independently of one another. Independent movement of the two table plates is advantageous in particular when peripheral regions of the workpiece are intended to be sawn. In this case, the workpiece can be placed on only one of the two table plates and fed to the saw blade. This also has the advantage that the user has their hands only on one side of the saw blade, with the result that working safety can be increased.

According to a further embodiment, the platform comprises at least one cross strut which is oriented substantially perpendicularly to the longitudinal direction and connects the first and second longitudinal guide together. The cross struts ensure that the longitudinal guides are connected fixedly together such that the gap region between the longitudinal guides is consistent. In particular, the gap region has a constant diameter along the longitudinal direction.

According to a further embodiment, a top side of the first table plate is arranged in a common plane with a top side of the first longitudinal guide, of the second longitudinal guide and of the second table plate. This has the advantage that the work table has a planar surface, via which the user can push the workpiece in the direction of the saw blade. The arrangement of the different parts of the work table in a common plane also prevents gaps or recesses arising, in which sawdust can collect.

A further aspect of the present invention relates to a sawing machine for stone materials, wherein the sawing machine comprises the following:
an abovementioned work table;
a saw blade which is arranged with respect to the work table such that at least a subregion of the saw blade is arranged or able to be fitted within the gap region between the first and the second longitudinal guide;
a suction-extraction device having a suction channel, wherein at least a subregion of the suction channel extends into the gap region.

According to a further embodiment, the suction channel of the suction-extraction device comprises a suction slot, wherein at least a subregion of the saw blade extends into the suction slot. As a result, the efficiency of dust extraction is increased, since the air flow of the suction-extraction device is applied directly in the area of contact between the saw blade and the workpiece.

According to a further embodiment, the suction channel comprises a top side which is arranged in a common plane with a top side of the first longitudinal guide and of the second longitudinal guide. The arrangement of the different parts of the work table in a common plane prevents gaps or recesses arising, in which sawdust can collect.

According to a further embodiment, the suction-extraction device comprises a collecting tank for collecting sawdust, wherein the collecting tank is arranged below the gap region. As a result of the collecting tank being arranged below the gap region, larger particles which arise during sawing drop into the collecting tank under gravity. Accordingly, such particles do not have to be picked up by the air flow of the suction-extraction device but can nevertheless be collected reliably and cleanly.

According to a further embodiment, the saw blade is connected to a drive shaft, wherein the drive shaft is arranged above the work table.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form useful further combinations.

In the figures:

FIG. 1 shows a schematic illustration of a stone saw with air extraction according to one embodiment of the present invention;

FIG. 2 shows a schematic, perspective plan view of a work table according to one embodiment of the present invention;

FIG. 3 shows a schematic cross section through a work table with air extraction according to one embodiment of the present invention;

FIG. 4 shows a schematic cross section through a work table with air extraction according to one embodiment of the present invention.

### DETAILED DESCRIPTION

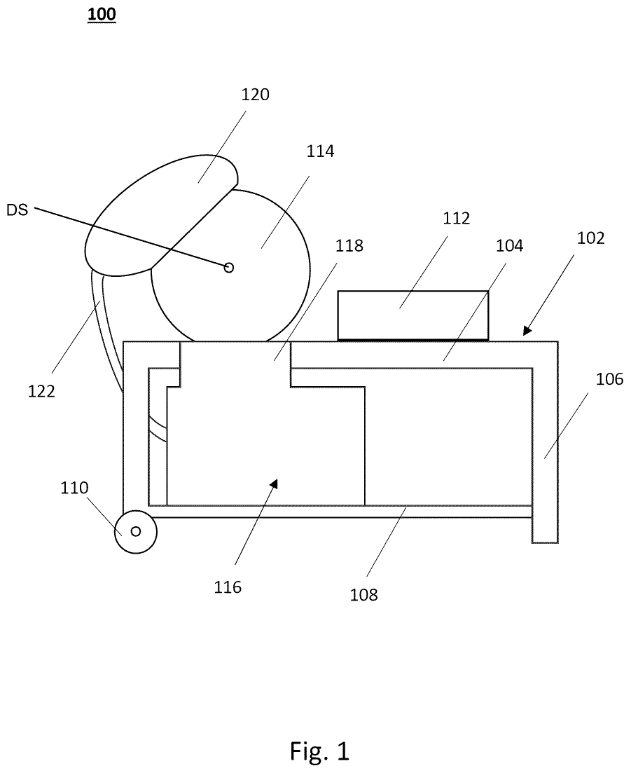

FIG. 1 shows a schematic illustration of a sawing machine according to one embodiment of the present invention. The sawing machine 100 according to FIG. 1 is a stone saw. The sawing machine 100 is in the form of a table saw. Accordingly, the sawing machine 100 has a frame 102 with a work table 104. The work table 104 can be connected to legs 106 of the frame 102. One or more legs 106 can be connected to rollers 110 in order for it to be possible to move the frame and thus the sawing machine 100 more easily. Arranged in a lower end region of the legs 106 is a shelf 106, which serves to carry a suction-extraction device 116.

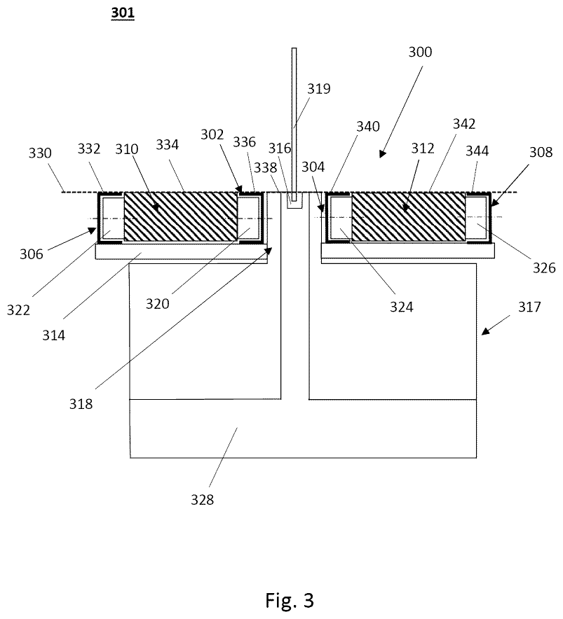

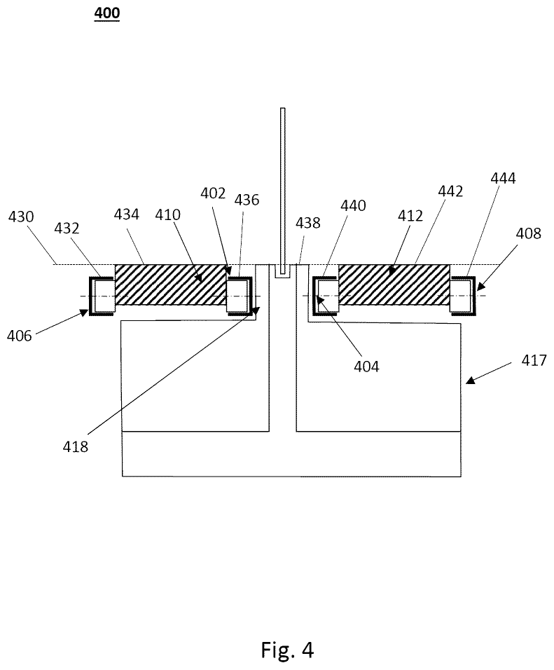

The work table 104 serves as a support surface for a workpiece 112. By way of example, the workpiece 112 may be a brick or concrete, or natural stone. In general, it is not impossible for other materials, for example wood, to be able to be sawn with the sawing machine according to the invention. As is apparent in particular from FIGS. 3 and 4, the work table 104 has table plates that are movable in translation. The table plates that are movable in translation can be used to move the workpiece 112 together with the table plates in the direction of a saw blade 114.

In the embodiment illustrated in FIG. 1, the saw blade 114 is arranged in particular above the work table 104 on a drive shaft DS shown schematically. The saw blade 114 can be carried by a saw arm which orients the saw blade with respect to the work table 104. FIG. 1 also indicates that a subregion, in particular a lower subregion, of the saw blade 114 extends into the work table 104. This ensures that the workpiece 112 can be cut through over its entire height and at the same time a particularly effective suction-extraction effect is achieved.

In order to extract the dust that arises when sawing the workpiece 112, the sawing machine 100 has a suction-extraction device 116. The suction-extraction device has a turbine which serves to generate a suction air flow. The suction air flow draws an air-dust mixture into the interior of the suction-extraction device 116 via a suction channel 118. Located in the interior of the suction-extraction device 116 is at least one filter for separating the dust out of the air flow. The dust filtered out of the air flow can then be collected in a collecting tank of the suction-extraction device 116. The collecting tank may be located, for example, directly below the suction channel 118.

The suction channel 118 is provided below the saw blade 114 such that it is arranged in the area of contact between the saw blade and the workpiece 112. Thus, the air-dust mixture is extracted directly at the point at which it arises. In order for it to be possible to control the dust formation even better, the sawing machine 100 according to FIG. 1 has a suction hood 120. The suction hood 120 is arranged on the saw blade 114 on a substantially opposite side from the workpiece 112. The suction hood 120 covers at least a subregion of the saw blade 114. In the embodiment illustrated in FIG. 1, the saw blade 114 rotates in particular in a clockwise direction. Air-dust mixture which has not been able to be removed directly by the suction channel 118 is captured by the suction hood 120. To this end, the suction hood 120 is connected to the interior of the suction-extraction device 116. In particular, a suction hose 122 can connect the suction hood 120 to a suction inlet of the suction-extraction device 116. Via the suction hose 122, the negative pressure generated by the turbine can be applied to the suction hood 120.

In the embodiment of the sawing machine illustrated in FIG. 1, the suction-extraction device 116 thus serves to extract dust via the suction channel 118 and the suction hood 120. Since the suction channel 118 is arranged substantially below the saw blade 114, gravity also makes it possible to collect heavy particles in the collecting tank of the suction-extraction device 116. This is the case in particular because heavy particles can drop into the collecting tank under gravity via the suction channel 118.

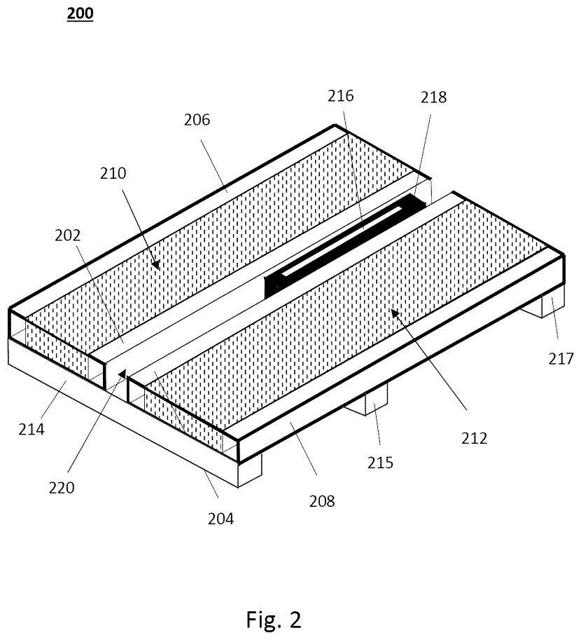

FIG. 2 shows a schematic, perspective plan view of a work table 200 according to one embodiment of the present invention. The work table 200 has a platform with a large number of longitudinal guides 202, 204, 206, 208. The longitudinal guides are connected together via one or more cross struts 214, 215, 217. The cross struts 214, 215, 217 extend substantially perpendicularly to the longitudinal guides 202, 204, 206, 208. It should be noted at this point, however, that the invention is not limited to perpendicular cross struts. Rather, the platform may comprise many further supporting elements which serve to orient the longitudinal guides with respect to one another. In particular, the longitudinal guides 202, 204, 206, 208 are oriented parallel to one another. In order to ensure the parallel arrangement, the longitudinal guides 202, 204, 206, 208 are fixedly connected to the cross struts 214, 215, 217 or alternative supporting elements.

A first table plate 210 is arranged so as to be movable in a longitudinal direction between a first longitudinal guide 202 and a third longitudinal guide 206. A second table plate 212 is arranged so as to be movable in a longitudinal direction between a second longitudinal guide 204 and a fourth longitudinal guide 208. In the embodiment variant shown in FIG. 2, the two table plates 210 and 212 are movable in a longitudinal direction independently of one another. However, provision may be made for the work table to comprise a synchronizing element which connects the two table plates 210 and 212 together. This embodiment ensures that the two table plates 210 and 212 are always moved together, i.e. synchronously, in the longitudinal direction. The synchronizing element may be connected in particular releasably to the table plates 210 and 212 such that the user can choose whether they would like to move the two plates synchronously or independently of one another. The synchronizing element may serve simultaneously as a stop and guide for the workpiece. For example, when the synchronizing element extends perpendicularly to the longitudinal direction, i.e. in the transverse direction, the workpiece can be oriented perpendicularly to the saw blade by being placed against the synchronizing element.

The first longitudinal guide 202 and the second longitudinal guide 204 are arranged between the two table plates 210 and 212. The fist and second longitudinal guides 202, 204 extend parallel to one another and are spaced apart from one another in the transverse direction. The spacing between the first and second longitudinal guides 202, 204 results in a gap region 220 between the first and second longitudinal guides 202, 204.

The spacing between the two longitudinal guides 202, 204 is dimensioned such that a suction channel 218 of a suction-extraction device can be arranged in the gap region 220. Specifically, the suction channel 218 extends from the housing of the suction-extraction device into the gap region 220. The suction channel 218 can extend over the entire width (transverse direction) of the gap region 220. In the longitudinal direction, the suction channel 218 according to FIG. 2 is dimensioned such that it extends only over a subregion of the gap region 220. This makes it possible in particular to insert one or more cross struts 215 in order to stabilize the platform. It is also conceivable, however, for the suction channel 218 to fill a majority of or the entire gap region 202 in the longitudinal direction between the first cross strut 214 and the last cross strut 217. In this case, preferably the middle cross strut 215 would need to be omitted.

Finally, it is apparent from FIG. 2 that the suction channel 218 has a suction slot 216. The suction slot 216 extends in the longitudinal direction of the suction channel 218. The suction slot 216 is designed to receive at least a subregion of the saw blade (FIG. 1). In particular, the lower part of a saw blade can extend into the suction slot. The suction slot 216 thus surrounds a subregion of the saw blade. The suction slot 216 is dimensioned such that, on all sides of the saw blade, i.e. towards the side faces or on the front and rear side of the saw blade, there is sufficient clearance for suction air to be drawn past the saw blade into the suction slot 216 and thus into the suction channel 218. Even with a longer configuration of the suction channel, i.e., for example, when the suction channel 218 covers substantially the entire longitudinal extent of the gap region 220, the suction slot 216 is preferably not longer than is illustrated in FIG. 2. Preference is given to adapting the suction slot 216 in terms of its extent in particular to the subregion of the saw blade which is received in the suction slot 216.

FIG. 3 shows a schematic cross section through a work table 300 with a schematic suction-extraction device 317 according to one embodiment of the present invention. The work table 300 according to FIG. 3 corresponds substantially to the work table 200 according to FIG. 2. In the embodiment shown in FIG. 3, too, the first and second longitudinal guides 302, 304 are spaced apart from one another in the transverse direction such that there is a gap region between the longitudinal guides 302, 304. A suction channel 318 of the suction-extraction device 317 extends from below into the gap region between the two longitudinal guides 302, 304. In the transverse direction, the gap, visible in FIG. 3, between the suction channel 318 and the longitudinal guides 302, 304 may be sealed off in order to prevent dust penetrating between the suction channel and the longitudinal guides. The suction channel 318 according to FIG. 3 also has a suction slot 316, into which a lower subregion of the saw blade 319 extends.

The suction channel 318 is connected integrally to the housing of the suction-extraction device 317. Located perpendicularly beneath the suction slot 316 of the suction channel 318 is a collecting tank 328, which is designed to collect falling particles or dust. Finer dust particles are conveyed by the turbine of the suction-extraction device 317 into a filter and separated from the air flow by the latter. The filter dust separated in this way can fall into the collecting tank 328 for example when the filter is cleaned. Alternatively, a separate collecting tank for the dust from the filter may be provided.

In the embodiment shown in FIG. 3, all of the longitudinal guides 302, 304, 306, 308 are configured as C-shaped profiles. In this case, the first and second longitudinal guides 302, 304 are arranged such that their open ends are directed away from one another. In other words, the rear walls of the C-shaped profiles of the first and second longitudinal guides 302, 304 delimit the gap region in the transverse direction. Here too, the longitudinal guides 302, 304, 306, 308 extend parallel to one another and are connected at their undersides to cross struts 314 to form a platform.

The first table plate 310 has one or more rollers 320, which are received in the first longitudinal guide 302. The rollers 320 of the first table plate 310 are movable in a longitudinal direction within the C-shaped profile of the first longitudinal guide 302. To this end, the rollers 320 are attached rotatably, in a known manner, to the main body of the table plate 310. The first table plate 310 also has one or more rollers 322, which are received in the third longitudinal guide 306. The rollers 322 are movable within the C-shaped profile of the third longitudinal guide 306. According to this embodiment, the third longitudinal guide 306 is arranged in a mirror-inverted manner to the first longitudinal guide 302, i.e. the open end of the C-shaped third longitudinal guide 306 is oriented in the direction of the open end of the C-shaped first longitudinal guide 302. The rollers 322, which are arranged within the third longitudinal guide 306, are connected rotatably to the main body of the first table plate 310.

The second table plate 312 has one or more rollers 324, which are received in the second longitudinal guide 304. The rollers 324 of the second table plate 312 are movable in a longitudinal direction within the C-shaped profile of the second longitudinal guide 304. To this end, the rollers 324 are attached rotatably, in a known manner, to the main body of the second table plate 312. The second table plate 312 also has one or more rollers 326, which are received in the fourth longitudinal guide 308. The rollers 326 are movable within the C-shaped profile of the fourth longitudinal guide 308. According to this embodiment, the fourth longitudinal guide 308 is arranged in a mirror-inverted manner to the second longitudinal guide 304, i.e. the open end of the C-shaped fourth longitudinal guide 308 is oriented in the direction of the open end of the C-shaped second longitudinal guide 304. The rollers 326, which are arranged within the fourth longitudinal guide 308, are connected rotatably to the main body of the second table plate 312.

The work table 300 according to FIG. 3 is configured such that a top side of all the longitudinal guides 302, 304, 306, 308 and the first and second table plates 310, 312 are arranged in a common plane 330. This results in a particularly flat top side of the work table 300, on which the workpiece can be moved without any obstructions relative to the saw blade 319. Specifically, the first longitudinal guide 302 has a top side 336 which extends along the common plane 330. A top side 332 of the third longitudinal guide 306 extends along the common plane 330. A top side 334 of the first longitudinal guide 310 also extends in the common plane 330. The second longitudinal guide 304 has a top side 340 which extends along the common plane 330. A top side 344 of the fourth longitudinal guide 308 extends along the common plane 330. A top side 342 of the second longitudinal guide 320 extends in the common plane 330.

It is also apparent from FIG. 3 that a top side 338 of the suction channel 318 likewise lies in the common plane 330. The shown top sides 332, 334, 336, 338, 340, 342, 344 jointly form a planar surface for supporting the workpiece.

An alternative embodiment of the work table according to the present invention is illustrated in FIG. 4. The schematic cross section according to FIG. 4 shows a configuration of the work table 400 in which only the top sides 434, 442 of the table plates 410, 412 and the top side 438 of the suction channel 418 lie in a common plane 430. In contrast to the embodiment according to FIG. 3, the top sides 432, 436, 440, 444 of the longitudinal guides 402, 404, 406, 408 are not arranged in the common plane 430. Rather, they are arranged in an offset manner with respect to the common plane 430, preferably downwardly, i.e. in the direction of the suction-extraction device 417.

The present invention is not limited to the embodiments illustrated in the figures, but results from a combination of all the features disclosed herein. In particular, the invention is not limited to the type of guides illustrated. These may also be, for example, sliding guides. The longitudinal guides are also not limited to the C-shaped profile. Rather, these may all have profile types which are suitable for guiding the table plates in the longitudinal direction.

### LIST OF REFERENCE SIGNS

100 Sawing machine
102 Frame
104 Work table
106 Table leg
108 Shelf
110 Roller
112 Workpiece
114 Saw blade
116 Suction-extraction device
118 Suction channel
120 Suction hood
122 Suction hose
200 Work table
202, 204, 206, 208 Longitudinal guide
210, 212 Table plate
214, 215, 217 Cross struts
216 Suction slot
218 Suction channel
220 Gap region
300 Work table
302, 304, 306, 308 Longitudinal guide
310, 312 Table plate
314 Cross struts
316 Suction slot
317 Suction-extraction device
318 Suction channel
320, 322, 324, 326 Rollers
328 Collecting tank
330 Common plane
332, 334, 336, 338
340, 342, 344 Top side
400 Work table
402, 404, 406, 408 Longitudinal guide
410, 412 Table plate
417 Suction-extraction device
418 Suction channel
430 Common plane
432, 434, 436, 438
440, 442, 444 Top side

What is claimed is:

1. A work table for a sawing machine, the work table being designed to carry a workpiece, the work table comprising:
a platform having a first longitudinal guide and a second longitudinal guide arranged parallel to the first longitudinal guide;
a first table plate movable longitudinally along the first longitudinal guide;
a second table plate movable longitudinally along the second longitudinal guide,
the first and second longitudinal guides being arranged between the first and second table plates, the first longitudinal guide being spaced apart from the second longitudinal guide perpendicularly to the longitudinal direction to define a gap region between the first and second longitudinal guides.

2. The work table as recited in claim 1 further comprising guide means received in the first longitudinal guide or the second longitudinal guide.

3. The work table as recited in claim 1 further comprising a third longitudinal guide arranged parallel to the first longitudinal guide and on an opposite side of the first longitudinal guide from the second longitudinal guide.

4. The work table as recited in claim 3 wherein the first table plate is arranged movably between the first and the third longitudinal guide.

5. The work table as recited in claim 1 further comprising a further longitudinal guide arranged parallel to the second longitudinal guide and on an opposite side of the second longitudinal guide from the first longitudinal guide.

6. The work table as recited in claim 5 wherein the second table plate is arranged movably between the second and the further longitudinal guide.

7. The work table as recited in claim 1 wherein the first or the second longitudinal guide have a C-shaped cross section.

8. The work table as recited in claim 1 wherein the first table plate is connected to the second table plate such that the first table plate is movable synchronously with the second table plate.

9. The work table as recited in claim 1 wherein the platform includes at least one cross strut oriented perpendicularly to the longitudinal direction and connecting the first and second longitudinal guide together.

10. The work table as recited in claim 1 wherein a top side of the first table plate is arranged in a common plane with top sides of the first longitudinal guide, of the second longitudinal guide and of the second table plate.

11. The work table as recited in claim 2 wherein the guide means are guide rollers.

12. The work table as recited in claim 5 further comprising guide means received in the further longitudinal guide.

13. The work table as recited in claim 12 wherein the guide means are guide rollers.

14. A sawing machine for stone materials, wherein the sawing machine comprises the following:
the work table as recited in claim 1;
a saw blade arranged with respect to the work table such that at least a subregion of the saw blade is arranged or able to be fitted within the gap region between the first and the second longitudinal guide; and
a suction-extraction device having a suction channel, wherein at least a subregion of the suction channel extends into the gap region.

15. The sawing machine as recited in claim 14 wherein the suction channel of the suction-extraction device includes a suction slot, and wherein at least a subregion of the saw blade extends into the suction slot.

16. The sawing machine as recited in claim 14 wherein the suction channel includes a top side arranged in a common plane with a top sides of the first longitudinal guide and of the second longitudinal guide.

17. The sawing machine as recited in claim 14 wherein the suction-extraction device includes a collecting tank for collecting sawdust, and wherein the collecting tank is arranged below the gap region.

18. The sawing machine as recited in claim 14 wherein the saw blade is connected to a drive shaft, wherein the drive shaft is arranged above the work table.
